(19) United States
(12) Patent Application Publication
(10) Pub. No.: US 2014/0324717 A1
(43) Pub. Date: Oct. 30, 2014

(54) METHODS AND SYSTEMS FOR RECORDING, ANALYZING AND PUBLISHING INDIVIDUAL OR GROUP RECOGNITION THROUGH STRUCTURED STORY TELLING

(71) Applicant: GoodSeeker, LLC, McLean, VA (US)

(72) Inventors: Erik AYERS, McLean, VA (US); Robert MORGAN, McLean, VA (US); Rob FRANKLIN, McLean, VA (US)

(73) Assignee: GoodSeeker, LLC, McLean, VA (US)

(21) Appl. No.: 14/263,707

(22) Filed: Apr. 28, 2014

Related U.S. Application Data
(60) Provisional application No. 61/816,212, filed on Apr. 26, 2013.
(60) Provisional application No. 61/930,991, filed on Jan. 24, 2014.

(51) Int. Cl. G06Q 50/00; G06Q 10/00

(52) U.S. Cl. CPC G06Q 50/01; G06Q 10/00
USPC 705/319

(57) ABSTRACT

Disclosed are methods and systems for recording, organizing, and analyzing behavior or conduct by individuals or groups through entry of story information and data related to one or more organizations known to the user, using a platform for internal or limited publication of the stories, and optionally, for external publication of the stories to elicit public feedback and recognition. The disclosed methods and systems use computer processors and databases, operating in real-time, to enable structured entry of story elements and descriptors relating to individual or group recognition; organization of the entered stories; analysis of the entered stories; and publication of selected entered along with analysis of story data to provide various indicators and scoring of users and organizations.

### TECHNICAL FIELD

The disclosed embodiments relate to methods and systems for individual or group recognition and, more particularly, to methods and computer-based systems for recording, organizing and analyzing individual or group recognition through structured story telling.

### BACKGROUND

Recognition of employee or group member work, effort, results, or successes is something that everyone, be it employee, employer, group member, or group leaders, wishes to see. Such recognition inspires everyone and moves the recipient and others to action. History has shown that such recognition is most effectively presented, acknowledged, remembered, and passed along through stories.

Storytelling and stories define the lives of everyone. Generations of cultures and organizations are described and explained through story telling. Science and research confirms that the human mind relies on stories as a key to understanding and remembering the things that are important in our lives. Stories most effectively capture important lessons and the lore of the past that need to be remembered and passed forward to future generations. Moreover, stories are the best way to inspire others into appropriate action and conduct. Indeed, employers and other organizations, including member associations, could substantially improve individual and group morale, fulfillment, engagement and overall work performance through effective use of storytelling.

All employers recognize the effect of disengaged employees. Studies have shown that disengaged employees result in lost annual productivity in excess of $300 billion. See Institute for Human Resources: 2013 Trends in Recognition: Utilizing Recognition to Drive Employee Engagement. On the other hand, engaged employees generally perform at least 20% better than disengaged employees, and engaged employees are 87% less likely to leave their employment. For example, those companies that are in the top 20% for creating and building an employee recognition-rich culture have a 31% lower voluntary turnover rate as compared to their peer companies who do not have an employee recognition-rich culture. See J. Bernsin, New Research Unlocks the Secret of Employee Recognition. Moreover, companies that effectively recognize their employees generate, on average, 27% higher profits, 50% higher sales and 50% higher customer loyalty for the company. See Institute for Human Resources: 2013 Trends in Recognition: Utilizing Recognition to Drive Employee Engagement.

Story telling has additional applications beyond use merely for individual or employee recognition. Traditional corporate marketing is becoming less effective. Most of the public have developed distrust for what an organization or company says about itself. Instead, the public wants to hear about, and to validate what an organization says through, third-party input, preferably “objective” third party input. Indeed, the creation and dramatic rise of the many Internet third party review websites is indicative of the public's demand for such “objective” information. Examples of such sites include, without limitation, Angie's List, Yelp.com, TripAdvisor.com, GlassDoor.com, and many, many others. The identification, capture and publication of authentic stories about an organization can help to improve marketing and the image of the organization, thereby better engaging current customers, prospective customers, partners, vendors, employee candidates and the public.

Indeed, as an attempt to improve the image or marketing story of itself, certain companies are resorting to funny or interesting images to present their image or message to the public. Televised commercials use a spokesperson (e.g., a sports figure like Peyton Manning), or an image (e.g., Progressive's Flo character), often a fantasy image (e.g., Geico's talking gecko, with a British accent), to present the company's image, products or services. These are in a very real sense an attempt to portray each company in a positive way by having a “third-party” present a positive story about the company.

Moreover, positive recognition always has been, and continues today to be, a primary inspiration and motivation for people. As evidenced by the ever expanding social networking platforms, many are seeking recognition, and recognizing others, for most any achievement. What is missing when it comes to organization marketing, and employee recognition and engagement, are easy to use tools that can be employed by individuals, companies and organizations to systematically collect, record, organize, select and properly publish positive stories, and to then analyze and associate those stories with the individuals or groups who deserve recognition for their positive role or contribution. Indeed, such a tool to provide for such positive recognition through the use of structured story telling is not readily available.

The use of email, meetings, print or on-line newsletters, or annual awards programs has been prevalent for years. While each of these have certain advantages or benefits in presenting information, none are effective at presenting and recording a relevant story, in real-time, that can be analyzed and selected for later publication for further public recognition and acknowledgement. For example, email, while often being immediate and in real-time, is very unstructured and most often does not include the attributes or elements necessary for a story. Further, email is most often limited because it has a directed audience.

Group meetings are similarly limited in that they are also unstructured, and are most often verbal with no structured recordation capability. Moreover, such meetings often lag behind when the accomplishment or success occurred and should be recognized. Further, given group dynamics and the setting of most group meetings, the same “strong personality” individuals will most often be recognized for their “achievements.” While print or on-line newsletters are a recorded means of presenting a positive story about an employee, such media suffer from a similar timeliness problem in that the written story will most often be untimely for proper recognition. Newsletters also centralize the manual effort with one or more people who may result in delays as that person or group is busy with other tasks. Finally, annual, or interim awards programs have similar issues with timeliness and with the centralization of the effort required to organize, create and present the recognition program. Moreover, awards programs have the same issue of not being public, and accordingly, having a defined and limited audience.

Current attempts to create a web-based recognition or rewards system are created to provide employees and/or managers a means to recognize the accomplishments of other employees through electronic feedback media, such as chat rooms or an enterprise social media structure. Such systems are focused on employer human resources aspects, and not on a structured means of recording a positive story that describes and illustrates an accomplishment or success that is worth recognizing. Moreover, these prior attempts do not provide for public recognition, for example, through a public website where positive stories could be used by an organization for positive marketing and image building, and to provide employees with the “wow” of true public recognition and fame.

### SUMMARY

What is needed are methods and systems to, in real-time, enable (a) structured and simplified entry of storing telling elements and descriptors relating to individual or group recognition; (b) organization of the entered stories using structured data; (c) analysis of the entered stories; (d) publication of selected entered stories for further recognition and feedback, both internally and publically; and (e) portable accounts and personal profiles that are not owned or controlled by a user's employer or organization. Such methods and systems should be able to easily capture, share, manage and analyze stories and the content of the stories. The methods and systems that are needed should allow for internal story capture, as well as internal and external contributors to and feedback about the stories. Such methods and systems would also allow for analysis of culture, value and brand status and alignment, and thereby allow for matching between individuals, and individuals and groups, including employers. Further, such methods and systems should allow for quantitative and qualitative analysis of the story's data and structure, including data associated with the story's principal elements such as setting, characters, goals, conflict, resolution, morals, lessons-learned and emotion. Such quantitative and qualitative analysis of words, numbers, images, symbols, context and other data sets associated with large numbers of related stories and narratives can reveal useful intelligence, trends, patterns and other types of metrics.

Accordingly, the best methods and systems should focus first on the entry and creation of story content, and second on the recognition and credit. The methods and systems disclosed herein provide such solutions to the above noted problems.

In view of the deficiencies with prior recognition and rewards systems, the disclosed subject matter, including computer implemented programs, of the embodiments are provided for improved identification, capture, inventory, analysis, sharing, and publication of structured stories. Individuals within an organization enter stories or multimedia information that are converted in networked platform into valuable and actionable insight and intelligence. The embodiments guide the user through the process of capturing structured stories related to projects and successes. These stories generate data for individuals and organizations that can be retained and analyzed.

Exemplary methods and systems provide the ability for employees or organization members to record, in a structured manner, stories of individual or group recognition using one or more of relevant text content, images, audio and video. The recorded stories are organized to allow for ready analysis and selection of certain stories for publication through a global communications network, to permit further feedback and recognition by public recipients.

In an exemplary embodiment, story-data and other user and systems generated story-information is processed in a manner that yields unique measures, metrics, indicators, trends, scores, rankings and other analyses or summaries. This data and information is uniquely applied to all aspects of enterprise engagement involving organizations, employees, students, groups, customers, members or individuals, and used to assess performance, achievement, culture, recognition, engagement and satisfaction, and branding.

An exemplary core architecture of the multi-platform enterprise according to the embodiments is a computer based system and associated software that allow for a structured means to capture and record the core elements and attributes of a story, where the “author” may use text content, keywords, tags, images, video, audio, and/or other descriptors. The computer based system is communicatively connected to a public global communications network, and to mobile devices thereby simplifying the story/data entry and story retrieval process for employees, organizations and others. The exemplary systems and methods further have analytics tools to compare and organize recorded stories, and provide recommended story presentations based upon selected metrics including industry, geography, employee role, member titles, identified keywords, and/or other metrics. In further embodiments, various analytics tools are used to quantitatively and qualitatively analyze aspects of the recorded stories, including an analysis of the words, numbers, images, symbols, context and other data sets associated with large numbers of related stories and narratives, which can be used to reveal useful intelligence, trends, patterns and metrics.

Advantages of the platform include applying simple structured story capturing technology to help organizations find, inventory and analyze story data; using story-data to show individuals the positive impact that they make on organizations they are associated with, and each other; providing users the ability to own their “story-profile” and to have it travel (portability) with them throughout their career. Further advantages include using peer-to-peer story data as a means for assessing employee engagement, workplace positivity and personal impact, and establish a public certification of workplace engagement and positivity using peer-to-peer stories and story data. The exemplary methods further provide a platform for story capture technology, structured peer-to-peer stories, and resulting story data, as a means for providing peer-to-peer recognition.

The platform may be used by individuals in ways including but not limited to understanding and monitoring personal brand, self-assessment of positive impact and contribution, strengths identification and personal betterment, delivering and tracking peer recognition, work legacy stories tracking and sharing, supplemental resume content and validation of impact, job matching between individuals and organizations. Further, the platform may be used by organizations in ways including but not limited to assessment of overall, individual or group positive impact and contribution, assessment of culture and alignment of stories with organizational mission, understanding brand (brand perceptions evidenced through stories), identification and sharing of organization improvement opportunities, identification and sharing of a lessons-learned knowledge base, delivering and tracking peer-to-peer employee recognition, providing public recognition to employees, support or replace existing employee rewards programs, augmenting employee performance reviews, idea generation, to show new employees story examples of topics that are important to the organization, to identify stories that can be used for marketing purposes.

If an organization needs to fill a role that fits a certain profile, the platform provide an efficient means of locating a candidate who has story profile that shows they are a match to the organization's needs. Organizational and individual impact scores and other metrics can be used to align candidate with the right job and organization.

The present disclosure provides these and other related benefits and advantages as described below and shown in the attached Figures.

### BRIEF DESCRIPTION OF THE DRAWINGS

The accompanying drawings are included to provide further understanding of the disclosed subject matter and constitute a part of the specification. The drawings listed below illustrate embodiments of the disclosed subject matter and, together with the description, serve to explain the principles of the disclosed embodiments, as disclosed by the claims and their equivalents.

FIG. 1 illustrates an exemplary architecture of a structured story telling recordation and publication system according to the embodiments;

FIG. 2 illustrates an exemplary embodiment of a two-part platform for a structured story telling recordation and publication system according to the embodiments;

FIG. 3 illustrates an exemplary embodiment of input flow and web presence creation for a structured story telling recordation and publication system;

FIG. 4 illustrates an exemplary method for creating a user profile according to the embodiments;

FIG. 5 illustrates an exemplary method for publishing to multiple organizations according to the embodiments;

FIG. 6 illustrates an exemplary embodiment of story input entry, including selection of key metrics, including themes, story lines, key values, and feelings associated with the story;

FIG. 7 illustrates exemplary embodiments of application interfaces for story data input entry;

FIG. 8 illustrates exemplary embodiments of application interfaces for output of user and organization status within the story database;

FIG. 9 illustrates a graphical representation of a participant's Impact Score; and

FIG. 10 illustrates software managers of the exemplary system according to the embodiments.

### DETAILED DESCRIPTION OF THE EMBODIMENTS

It will be readily understood that the components of the present invention, as generally described and illustrated in the, Figures herein, may be arranged and designed in a wide variety of different configurations. Thus, the following detailed description of the embodiments of the apparatus, system, and method of the present invention, as presented in the Figures, is not intended to limit the scope of the invention, as claimed, but is merely representative of selected embodiments of the invention

Reference throughout this specification to “a select embodiment,” “one embodiment,” or “an embodiment” means that a particular feature, structure, or characteristic described in connection with the embodiment is included in at least one embodiment of the present invention. Thus, appearances of the phrases “a select embodiment,” “in one embodiment,” or “in an embodiment” in various places throughout this specification are not necessarily referring to the same embodiment.

Furthermore, the described features, structures, or characteristics may be combined in any suitable manner in one or more embodiments. In the following description, numerous specific details are provided, to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

The various embodiments provide exemplary methods and systems for recording, organizing, and analyzing individual and group behaviors, actions and related achievements through structured storing telling processes, along with a platform for publishing selected stories both internally and publicly for broad feedback and recognition. Leveraging the power of computer processors, and the Internet, the exemplary methods and systems use computer processors and databases, operating in real-time, to enable (a) structured entry of story-telling elements and descriptors relating to individual or group recognition; (b) organization of the entered stories; (c) analysis of the entered stories, both on an individual and aggregate basis; and (d) publication of selected of the entered stories for further recognition and feedback.

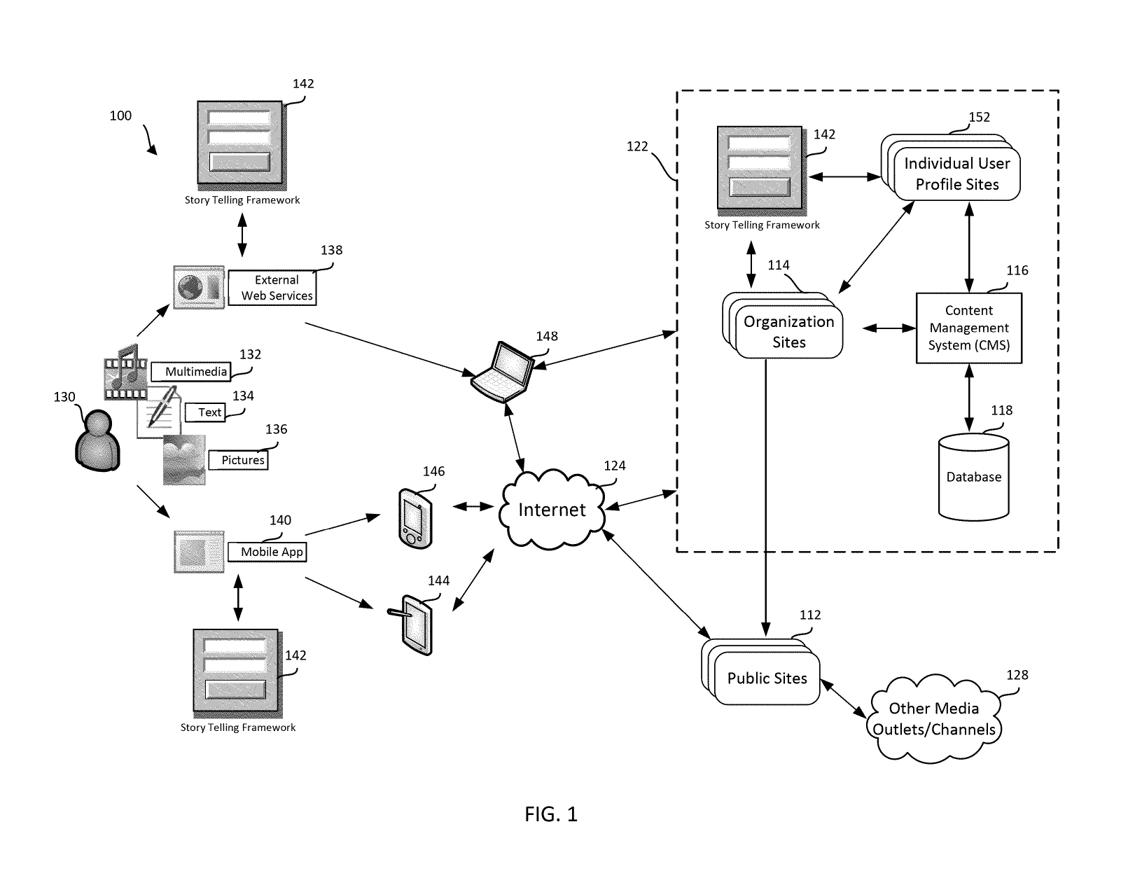

Referring now to the drawing, in which like reference numbers refer to like elements throughout the various figures that comprise the drawing, FIG. 1 shows an architecture of an exemplary system 100 that includes specialized computers, processors, and software capable of operating and implementing the methods of the embodiments. In a preferred embodiment, the system 100 includes computer servers 112, 114 that are communicatively connected to each other as well as being connected to a content management system 116 and to one or more databases 118.

The components of the platform, in an embodiment, are managed on a server that could also be a system cloud computing environment. A cloud system typically refers to a service for outsourcing computational or data sourcing needs to a third party that owns or licenses the cloud software and hardware infrastructure and makes it available over Internet or other network connections. In some embodiments, cloud system 122 may be a server delivering software as a service (“SAAS”), platform as a service (“PAAS”), or infrastructure as a service (“IAAS”). FIG. 1 further shows such an embodiment where the public computer servers 112 may also be communicatively connected to the system cloud 122, and in turn the system cloud 122 is connected to a global communications network 124, such as the Internet. Content management system 116 includes an application manager, which is managed by an administrator, which executes the software functions of the platform. Such exemplary features include receiving and administering story and data submissions from users via the private sites 114, executing software for, and administering, user profile sites 152, private sites 114, and public sites 112, and administering flow of stories from private sites 114 to public sites 112. Administrators of the content management system control the publication of selected or nominated stories from organization sites 114 to the platform's public site 112, and alternatively an administrator of the platform controls publication to the platform's public site. An administrator of the platform determines which stories to give additional publicity, recognition, or awards to stories published to the platform's public site. In addition, in an embodiment an organization may publish stories from the organization's site instance 114 to public sites 112 or other external media 128. Because the Internet 124 is a public network, the system 100 is connected at all times to other media outlets 128 through public site 112 which may include print media (e.g., newspapers, magazines, periodicals), as well as radio, television, or other websites such as YouTube or other social networks.

In the exemplary embodiment, illustrated in FIG. 1, the entry of story content from remote users can occur using computing and mobile devices that are networked to Internet 124. Author or system user 130 may include, but is not limited to, an employee, a member of a group, a member of an organization, or an individual. User 130 can enter a story with any associated information such as text or documents 134, multimedia including audio/sound or video files 132, or graphics or photographs 36 to system web-based services 138, or to the system mobile application services 140. Both the system web-based services 138 and the system mobile application services 140 use proprietary software 142 that collects, and organizes, the author's data input in a structured format along with tags and metadata, as is described in more detail herein. Entry of story content and information to the Internet 124 may be, by way of example, from the mobile application 140, via a tablet or other type of computing device 144 or a smart phone type device 146. Alternatively, the story capture may use mobile alphanumeric and visual tags. These techniques allow a user to quickly capture the story elements, which are then loaded through a user profile interface 152 and saved in a database 118 as a draft for later completion or as a final entry. As also shown in FIG. 1, the communication flow from the private servers 114 to public servers 112 can be freely allowed or managed to ensure that confidential or proprietary information is only allowed to be disclosed when the appropriate disclosure requirements are met. A user 130 may publish a saved story to private customer site 114 but cannot publish directly to public site 112. In an additional embodiment, entry of story content and information to the Internet 24 may also be, from the web-based services 138, via a laptop or similar computer device 148.

In another embodiment, the entry of story content by the author/user 130 could alternatively occur through direct access to one or more private servers 114. In such an architecture, the private 114 servers would operate proprietary software 142 used to record and organize the entered story content. Such an embodiment would be for companies or organizations with users being directly connected to the company or organization servers.

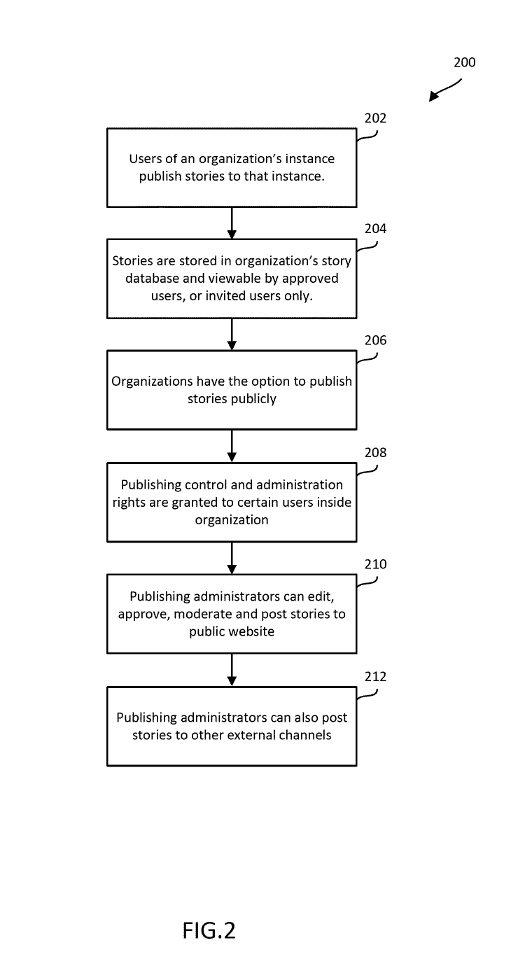

As described in the flowchart in FIG. 2 and above, the exemplary systems and methods form a two-part or dual platform. The platform provides organizations the tools to capture and share stories about the good topics that highlight what makes the organizations special. These stories are very useful for internal purposes including employee recognition and knowledge sharing. These authentic employee generated stories also have a lot of external value for marketing and branding purposes. The embodiments provide organizations the ability to take those good stories and share them with the world to support marketing and branding purposes. Organizations may alternatively publish selected stories to a third party website, such as GoodSeeker.com, that is an aggregator of good stories for organizations for internal purposes that also wish to promote stories publicly. The external server and website provides organizations an additional way to promote internally-generated stories that are more likely to be believable by customers, prospects, partners, and recruits. For example, a potential new hire may go to the site to read user generated stories about a potential employer as a way to supplement the information that has been shared by the company. A potential customer may decide to read stories posted on the third party website as a way to better understand a company's culture of client service through the eyes of users themselves, not a marketing department. Thus a third party website can be used for internal uses (e.g., employee recognition) and external uses (e.g., marketing).

In the first part of the platform, exemplary features include the structured recording and organizing of story content using the proprietary software 142, public 112 and private 114 servers, content management system 116, and the information databases 118. Recordation of a story has structure and exemplary data associated with its principal elements including such elements as setting, characters, goals, conflict, resolution, morals, lessons-learned and emotion. Story data recorded by the platform includes all user or computer generated alphanumeric data associated with unstructured narrative, story tags, narrative prompts, emotion selections, and any other data specifically related to a published story. Organizations can customize the platform to include options and tags related to certain themes or topics that are important to them. Alternatively, recordation may include unique cultural attributes, values and other important organizational behaviors. Through the analysis of stories and story data the platform analysis function can determine alignment, or lack thereof, with desired culture attributes.

The features of the first part of the platform also allow a user, using the proprietary software 142, to analyze the recorded stories and to select or identify the best stories for publication. Accordingly, the embodiments provide the ability to broadcast or publish certain of the stories to, for example, support marketing objectives and allow for public recognition of an individual's or group's behaviors, achievements and/or successes.

Referring again to FIG. 2, an exemplary method of publishing stories using the dual platform is illustrated as flowchart 200, which shows the distinction between the first part of user engagement being used in a controlled sharing of the stories to create marketing believability under the second part of the platform. In step 202, users of an organization's instance of the platform publish stories to that instance. Stories are stored in the organization's story database and may be viewed by approved users, or alternatively, invited users only 204. Next, organizations may choose not to keep a story private and instead publish the stories publicly 206. The publishing control and administration rights for public dissemination are granted to certain users within an organization in step 208. These publishing administrators can edit, approve, moderate, and post stories to public website customized for the publication of stories from platform 100, such as Goodseeker.com in step 210, or to an organization's own website. The publishing administrators can also post stories to other external websites or other channels in step 212.

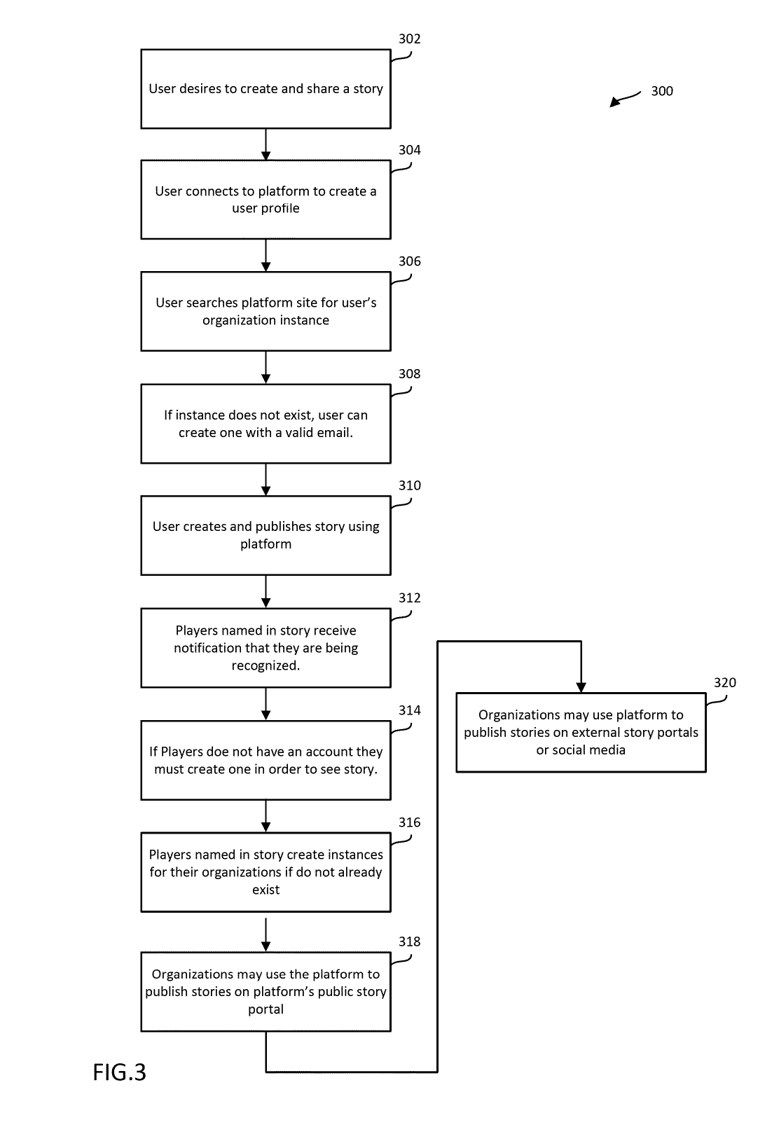

An exemplary process for recording a positive story about an individual or group is shown, in an exemplary embodiment, in the flowchart 300 of FIG. 3. As illustrated, a user may see or hear, in step 302, of an notable or positive story reflecting another individual's, or a group's, behavior, achievement or success, that he or she would like to recognize and publicize. Examples of stories include, but are not limited in the embodiments to the following:
a) Good customer service, that saves a client
b) Teamwork and collaboration to gets work done faster
c) Extra effort without being asked that relieves pressure on someone else
d) Finding new ways to fix problems that have persisted
e) Doing things that help the community
f) Someone putting someone else's interests ahead of their own
g) Stepping out of one's comfort zone to learn something new
h) Someone introduces a bold idea without fear
i) Someone who uses a positive attitude to motivate a team that has a low morale
j) The story and people behind winning new customers or projects
k) The story behind a difficult decision
l) Story about breaking down internal barriers to be more effective
m) Someone who paid attention to the little details that make an event great.

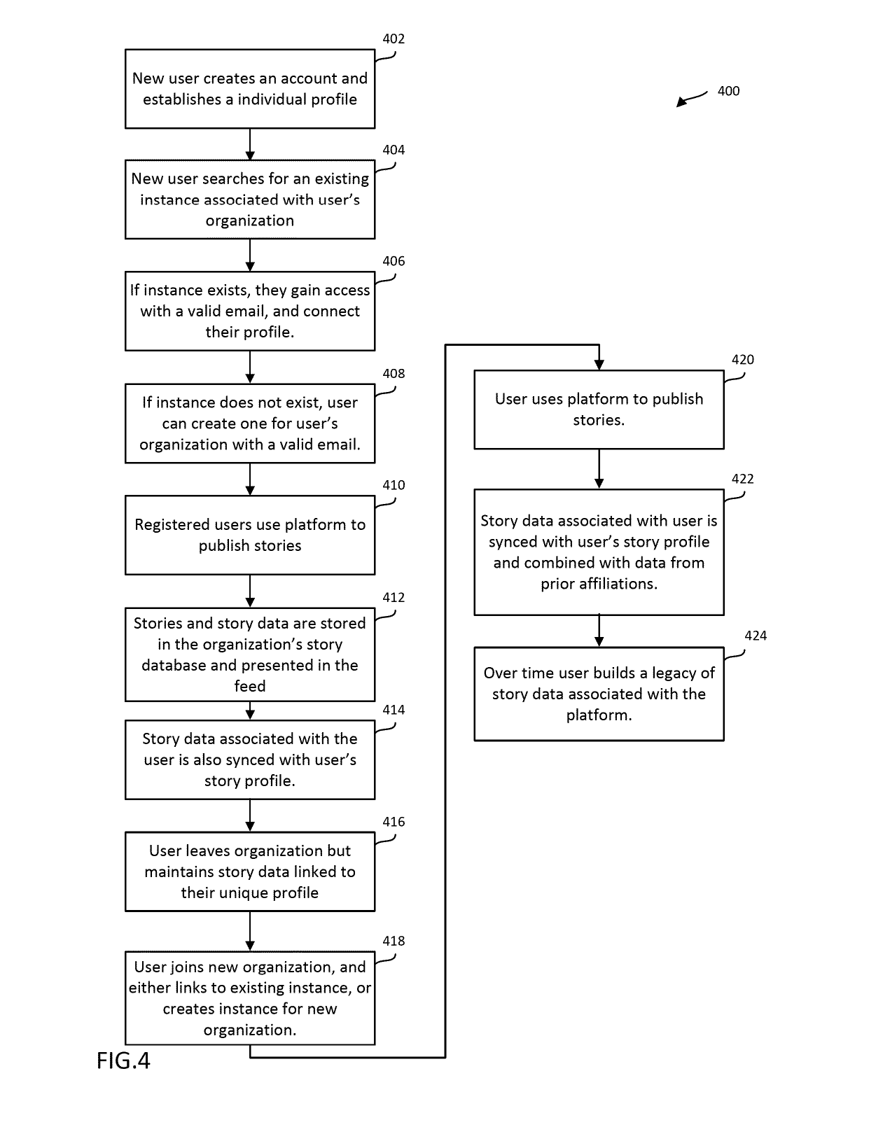

In one embodiment, such publication of the behavior or achievement would be limited to internal distribution. In such a case, the individual creates a user profile within the platform 304. The User Story Profile is a unique depiction of an individual's personal brand, work legacy and positive impact. This profile is owned by the user and is built upon for as long as they are a registered user. An exemplary method for creating a User Story Profile and organization is further described in FIG. 4.

Flowchart 400 in FIG. 4 shows an exemplary method for a new user 130 to establish an account and individual profile. In step 402, a new user creates an account and establishes an individual profile. The user establishes the instance with limited information. User-generated limited organization instances contain little administrative, customization publishing and reporting features. Next, the user searches for an existing organization instance (i.e., account) associated with their own organization 404. Instances are versions of the platform application that are specific to an organization, whereby access is limited to valid users, such as those with a valid organization email address, or those who are granted full or limited access by an administer of the instance. If the organization instance exists, the user gains access to the organization's instance with a valid email. Once an email address approved by the organization, a user can connect their account to an organization's instance 406.

If an organization instance does not exist on the platform, a user can establish a “limited instance” using a valid email address. In an embodiment, an organization entity is created within the cloud 122 as the entity comprising users and groups. Organizations could be any of a non-limiting exemplary group, team, business, company, or national or international body. Each organization has a profile. Part of the organization's profile includes data and analysis related to the stories captured by members, users, customers, and others; stories where the organization is named. The organization story profile is a unique depiction of an engagement, brand, and culture captured by stories. Access and exposure of certain aspects of an organization's profile may public, or alternatively kept limited or otherwise controlled. When an organization already has an instance, a new user can link their account (and profile) so long as the user has an email that is validated by the organization. If an instance has not already been created for an organization, a user can do so with a valid organization email address. A “limited instance” set up by an individual user, for an organization, has limited functionality until an organization administer is assigned, and the version of the instance is upgraded.

According to an embodiment, a verified organization may be granted a full instance, which provides additional features and controls related to, but not limited to:
a) Customization, i.e. tailor story options and types
b) Administration, i.e. creating groups
c) Public Sharing Options, i.e. the ability to publish to externally
d) Reporting, i.e. ability to see trends, statistics, etc. at the organization, group level.
e) National benchmarking, i.e. participate in benchmarking efforts
f) Certifications and Seals, i.e. be eligible to use Organizational Authentic Seal
g) Support, i.e. dedicated technical support and related services

In step 410, after establishing the account, users can use the platform to input and publish stories and include other emails and names of people in the same organization. Stories and story data are stored, along with the user profile, in a story database and presented to a website feed in step 412. Story data is also associated with the user and synchronized with the user's profile 414.

In an embodiment, those individuals named in stories are termed “players” and receive an email or other notification containing an invitation to join the platform when they are named in stories. The user-base grows inside the organization using this peer-to-peer story sharing approach. Organization administrators can also promote the platform signups through internal communication efforts, contests, incentives, etc. The user-base also grows through cross-organization story sharing. In an exemplary embodiment, individual account holders can capture and share stories about organizations and individuals who are not connected to their organization. However, the external users do not have the ability to see that organization's feed or to access organization directories without a valid email address or authorization from the organization.

If a user leaves the organization that the user is currently associated with, the user's profile is portable and does not stay under control or ownership of the organization. The user maintains the story data that is linked to the user's unique profile 416, which is portable with the user and can follow the user to a new organization. When the user joins a new organization, the user may either link the profile-associated stories to the instance of the new organization, or create a new profile for the new organization in step 418. Regardless of the instance being linked with, the user uses the platform to publish stories 420, where the user's name is associated with the story via metadata or other means known in the art. The stories remain associated with the user's profile and may be combined with stories and data from prior or future organization affiliations 422. Over time, the user builds a legacy of story data associated with the profile and with the platform 424.

Referring again to the exemplary flowchart 300 in FIG. 3, a user may search the platform for his or her own organization 306 and link to the system to create a specific company or organization story site in step 308, if such a site did not previously exist. Through the use of proprietary software 142, the user is guided through a series of structured steps to enter the key story elements and metrics. Part of the user profile includes data and analysis related to the stories the user captures, the stories the user is named in, and the user's contribution to other's stories. To facilitate the usage of the system, in a preferred embodiment, the individual entering the story can quickly enter or capture a limited number of items by marking the memory of the story with a few key attributes. These memory marks or attributes, when combined with reminders and alerts, can serve as the basis for completing or filling out the story at a later time.

Once entered, recorded and organized within the system databases 118, the individual can now broadcast for internal distribution and recognition 310, or seek via email, in step 312, input or comments about the story from other employees, members, or other individuals who may have contact with or are recognized in the story. Published stories are first shared within the organization's instance feed, unless an organization administrator gives users the ability to share only within a specified group. Through the broadcast or seeking input from other individuals, employees or organization members, the network of individuals seeing the story and being able to comment on, or provide further input about, the story publicity increases.

In a preferred embodiment, new users who are within the same organization as the story creator or originator may also join or link, in step 314, to the company instance, instead of merely providing comments about the recorded story. Individuals who comment on the story, but who do not reside within the same organization as the story originator, may be given the opportunity to create their own organization story site in step 316, but are not provided access to the stories associated with the originator's organization unless the external individuals have the appropriate authorization.

In many organizations, groups exist based on departments, geographies, and other alignments. In some cases, it is more appropriate for stories to be published only within the group. The platform provides users the ability to create groups and subgroups. Upon registration, users can associate with established groups. The establishment of groups also acts as an initial testing ground for users who may not be comfortable with sharing their stories to a large group. However, when a group is established, and stories are contained within that group's feed. As an alternative, the top stories for the group will always be shared on the organization's private site 112. A further embodiment permits each new individual who comments on the story to similarly link the story to his or her different network of contacts. Because each new individual likely has a different network of contacts and potential further contacts, the network of individuals connected to the story could grow exponentially.

In a further embodiment to facilitated sharing of stories, in step 318 an organization is able to publish stories on the platform's own story portal. In step 320, stories can be published on external story portals or social media. As a result of publication, individual users whose stories are published externally receive public recognition, and organizations may receive marketing benefit for publishing the stories. Alternative embodiments allow the system can be integrated with, and distributed by means including but not limited to:
a) An Organization's feed
b) A Group feed
c) The feeds of other connected organizations
d) Corporate intranets
e) Performance review systems and appraisal systems
f) 3rd party enterprise applications
g) RSS feed readers
h) Email newsletters (Internal and External)
i) Social media platforms
j) Organization's external websites

In an alternative embodiment, the exemplary platform may be used to further connect to, and capture stories related to, secondary organizations. A “primary organization instance” is an instance belonging to a user's organization, while a “secondary organization instance” or an “individual instance” are organizations or individuals that are not a part of the primary organization. Secondary organizations may be work related or personal to an individual. The architecture of the platform 10 allows for individuals to capture and share stories related multiple organizations, i.e. secondary organizations. Secondary organizations can be “personal” or “work connected.” An example of the personal organization is where the user captures and shares a story related to a non-profit community organization they are involved in. An example of a work-connected organization is where an employee tells a story that includes an individual associated with a customer of the primary organization. In both cases, the user is capturing stories and story data that are valuable.

The ability to capture and share stories that are not directly related to a user's current, or primary, organization is an exemplary feature of the platform. The ability for a user to capture stories beyond the primary organization gives users the opportunity to build a clearer picture of the positive impact they make inside and outside of the workplace. It is also a way to extend the platform to new organizations and individuals. For work related organizations, primary related organizations may include partners, customers and clients, and vendors. For personally connected organizations, related organizations may include community and volunteer organizations, personal service providers, and retailers.

In some embodiments, a user can contribute stories to organizations and individuals who are not directly related to a user's primary organization or workplace. The data associated with these “personally connected” stories is also valuable to the user. Thus, stories and associated story data are linked to the user's story profile and story database. An example of this is a user who experiences a great example of customer service when dealing with a retail establishment. The user can capture the story and share it with another individual via email. In this case, persons named in the story receive an email alert or other alternative methods for notification (e.g. text message, email, or notification through other third party or social media applications) letting the named persons know that they have been named in a story. If an external recipient has a user account, the user can log in to see the story. If external user does not have a user account they are prompted to create one prior to seeing the story. At that time the external user can also decide to create an instance for their organization if one does not already exist. The external user is also prompted to create a “limited instance” if one does not already exist for the new user's organization. When a user does not have the email of a particular person, they can search for a general email through a connection with white pages, another data provider, or through other social media connectors.

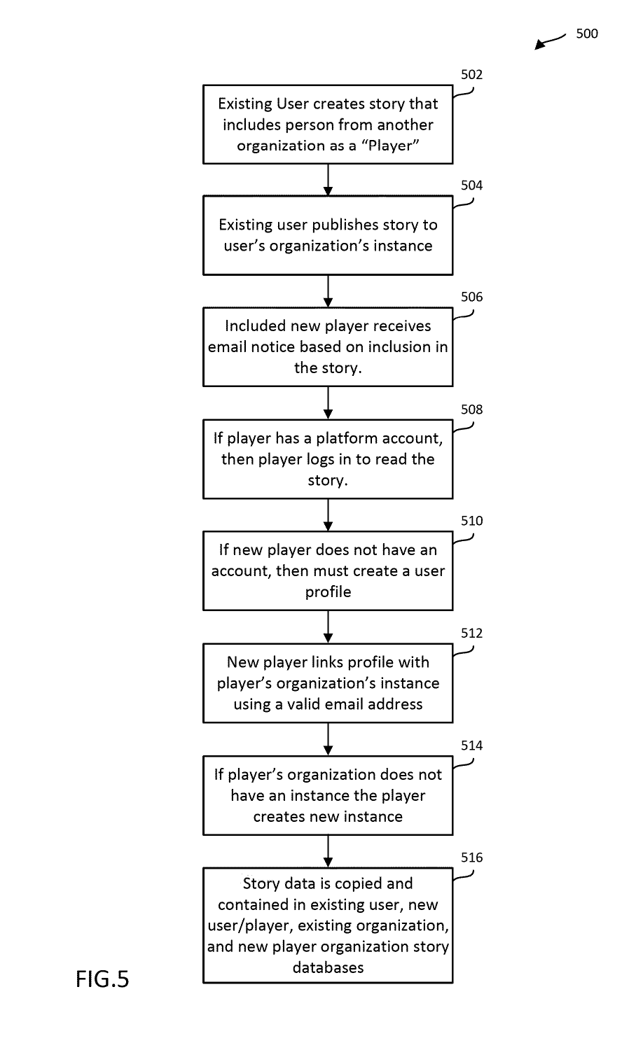

Referring to FIG. 5, flowchart 500 shows an alternative embodiment of an existing user connecting with other organizations and individuals outside of their primary organization. The process begins 502 with an existing user creating a story that includes another person from another organization which is termed herein as a “player.” In step 504, the existing user publishes a story to the user's organization's instance that includes the player in the story. The new player then receives an email notice based on the player's inclusion in the story in step 506. If the player is already a registered platform user and has an existing user profile account, then the player logs into the account to access and review the story in step 508. However, if the new player does not have a user account, then the player must create a new user account in step 510 according to the exemplary methods described herein. Next, in step 512 the new player links the new profile with the player's organization's instance using a valid email address. If the player's organization does not have an instance, then the player creates a new instance 514 according to the exemplary methods described herein. One the new player creates and account, or links a new account, to the story the article is then linked or contained within the existing user and organization and the new player user and organization 516.

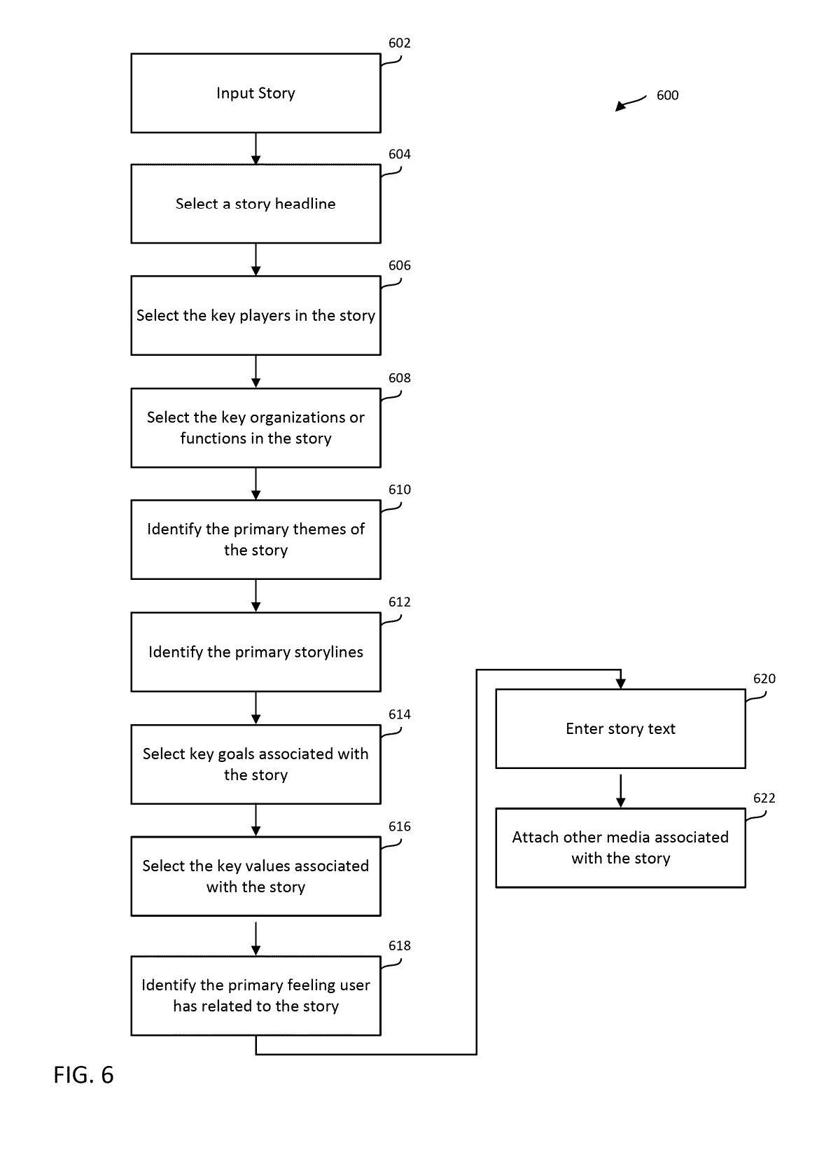

Referring to FIG. 6, in further detail relating to the structured aspect of the information entry, flowchart 600 shows an exemplary embodiment of how a user may be guided through the process of entering story metrics to create a user story profile that can be readily recorded and organized for later analysis. There are many types of stories that a user will capture that involve their workplace and other personally connected organizations and individuals. To make the process more efficient, and to facilitate the capturing of story data, the platform provides the user options to select the type of story they want to create. These options trigger other automated aspects of the platform including story prompts described below. In this exemplary embodiment, upon the user 130 deciding he or she wishes to input a story in step 602 about another's actions, achievements or successes, the proprietary software 142 guides the user 130 to, in turn, select a story headline in step 604; select the key players in the story in step 606; select related teams, groups, or key functions or organizations in step 608; identify any story themes in step 610. Exemplary themes may include, but are not limited to, the following topics:
a) Family—stories related to family members
b) Friends—stories related to friends
c) Work—stories related to work
d) Industry—stories related to certain types of industries
e) Function—stories related to certain functions in the workplace.
f) Hobby—stories related to certain hobbies
g) Sports—stories related to user as a participant, spectator, fan of, etc.
h) Relationship—stories related to family, peer, mentor, coach, teacher, customer, etc.
i) School—stories related to school, i.e. college, high school, grade school.
j) Themes—stories related to specific themes or topics
k) Tone—stories related to humor, seriousness, inspiration, etc.
l) Location—stories related to a region or geography that may be localized

Continuing the method in FIG. 6, in step 612 primary storylines are identified; the key organizational goals to be associated with the story are selected in step 614; and key organizational values that should be associated with the story are identified in step 616.

Capturing a story with complete details and context that are aligned with an organization's goals and values is an important part of the exemplary process. In an embodiment, the platform provides methods to simplify the story capture process by giving users the ability to quickly pick keyword and selections such as images or tags that help to describe the story. We call these narrative prompts. Narrative prompts are dynamic and relational, make it easier for the user to complete the story, and facilitate the capture of structured data for further analysis. An organization using a “full instance” of the platform provides functions for story entry by including additional story selection options. Options include but are not limited to giving users the ability to create and associate stories with groups, the ability to select job title, function, role, etc., and providing narrative story prompts and selections.

Narrative prompts are dynamic. Narrative prompts change, in composition, ordering, or emphasis, based on the frequency user selection. As usage increases the selection prompts change; as new user-generated options are added and chosen they start to show up more frequently. Selection options are refined based on how many users select, or add to, certain story description lists. For example if 50% of the user base adds or selects the word “limited time” as an obstacle in their story, the phrase “limited” time can appear at the top of the list.

Narrative prompts are also relational. In the embodiments, narrative prompts presented to users are determined based on relation to other story selections. The existence of relationships between prompts can be established by preloaded functions in the software, by an organization, or as a result of user selections. For example, when one selection is chosen (i.e., what was the obstacle), proceeding selection options (i.e., how was the obstacle overcome) are refined and presented in a relational manner. Narrative prompts can be related to story themes, industry attributes, role specifics, etc. Examples include:
a) If the user selects a story theme of “x”, then the proceeding narrative prompts related to story challenge/obstacle will be “y”.
b) The presentation of different narrative prompts if a person is writing a story related to a healthcare company vs. a law firm.
c) The presentation of different narrative prompts if a user is capturing a story related to the theme of teamwork vs. client service.
d) Where the user-selected story theme of “community service” presents a unique set of tags when a user is prompted with the question, “how does this story make you feel?”

The platform encourages users to associate the story setting and impact of the story on the storyteller, through the use of symbols colors, audio and images. Story setting can include emotion and feeling tags and symbols, colors, audio and images. The storyteller is presented with options to associate these items with different parts of the story. These selections also produce story data used for analysis.

The ability for the storyteller(s) to include an indication of the story's positive impact on them is a key element of the platform. This helps to make recognition meaningful and is critical for effective peer-to-peer recognition. At the end of every story the storyteller can make selections that clarify the story's positive impact on them. Stories that include this are much more powerful and more clearly show people the impact of their efforts.

The platform includes the ability to create notes that can be later associated with a story, and included as part of a published story. Notes can also be added to an already published story by anyone who is named in the story. Notes can take the form of text, video, pictures, audio and other file types. The user can group notes and share notes with other people who are working together to capture a story.

From time to time a user may see a story that is published that reminds them of something that they heard about from someone else. The platform allows the user to forward the published story to someone else along with a suggestion that they capture a similar story. This is also a way for one individual to encourage another individual to recognize something or someone. For example, a sr. manager may nudge a junior manager to capture a story about something a staff member did because the senior manager is trying to train the junior manager on how to motivate people. In an embodiment for a group case, an individual begins the creation of a story by including one or more than one element such as; a headline, the selection of certain story tags, themes, etc. Narrative related to the story may be blank. The user can then forward the incomplete story to others who they would like to complete. Each user then creates and publishes their version of the story. This is used when it is valuable to get multiple points of view and different lessons learned. For example, a team who wins a big project can each share their view of the win story as well as the lessons-learned. These stories can be grouped and used for knowledge sharing as well as recognition.

In the embodiments, users' stories are captured in a way that includes emotional context. Thus story data is being used to understand attitudes, feelings and emotions. Emotional attributes are captured in two areas; story setting and emotional impact. First, storytellers are given the ability to add emotion associated with story setting. For example, in telling a story about a team that faced a new challenge, but came together in a new way to overcome it, the storyteller can select the emotion tag of “anxious” to describe how the players were feeling when faced with the challenge. The second area for sentiment analysis is related to the emotional impact of the story on the storyteller. Here the storyteller is prompted to answer the question, “what was the stories impact on you?” The storyteller can select an emotion tag of “inspired,” among many others. The selection of emotion impact tags helps individuals better understand the positive impact their efforts make on others.

Thus, continuing with the method illustrated in FIG. 6, the next steps in the process is to identify primary feelings and emotions the author has about the story and the potential or likely impact of the story on the author and the organization in step 618; enter the text to describe the story in step 620 through the prompted story telling questions; and finally to attach or enter other media, such as music, pictures, graphics or video that should be associated with the story in step 622. Of course, these steps and metrics can be fully customizable by the organization to focus the story telling elements to attributes that are important to the organization.

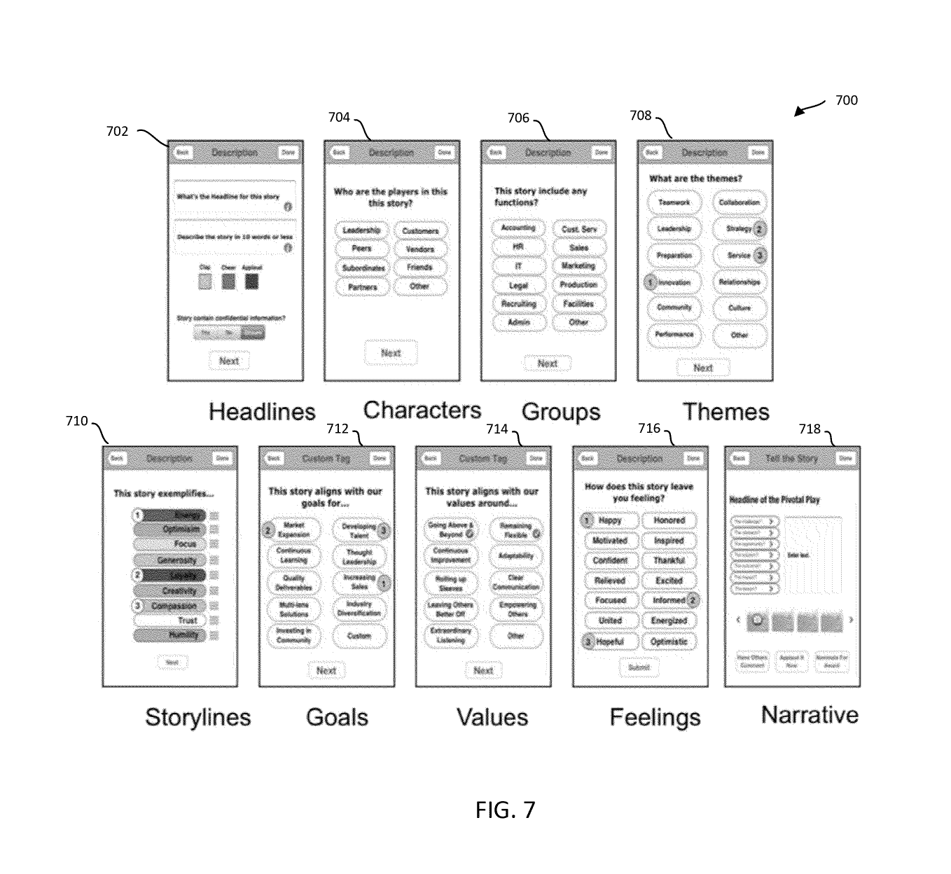

By way of one example for a mobile device, such as a tablet 144 or smart phone embodiment 146, FIG. 7 shows associated screen images 700 on graphical user interfaces for steps included in the story input method described in FIG. 6. Although embodiments shown in FIG. 7 and disclosed herein describe specific user inputs to support a story or article, one skilled in the art should understand that the input screens, topics, information, and selections are merely exemplary and may vary without deviating from the scope or equivalents of the present invention. As illustrated in FIG. 7, the story headline screen of step 604 could have the user 130 identify the headline in screen 702 and also describe the story in a limited number of words. The information sought at this initial level could also request information about whether the story contains confidential information which may warrant further security of the information being entered, or further security to prevent improper disclosure to the public. A story's key players and characters screen 704, related to step 606, provides examples to the user 130 of persons such as leaders, customers, friends, and subordinates. In addition to key players, group functions may be entered in screen 706 that identify categories of organizational functions that the players may be associated with such as Accounting, Human Resources, Information Technology, Legal, Recruiting, Administration, Customer Service, Sales, Marketing, Production, etc. Other embodiments for GUI input screens include input for themes 708 in step 610 such as teamwork, leadership, strategy, innovation, and community. A storyline description called for in step 612 can be fulfilled with input into screen 710 with such exemplary inputs as energy, optimism, focus, generosity, loyalty, creativity, compassion, trust, or humility. For inputs related to key goals in step 614, screen 712 provides the user an interface to select general or customized goals that aligns with the story, such as market expansion, continuous learning, quality deliverables, multi-lens solutions, investing in community, developing talent, thought leadership, increasing sales, or diversification. Key values in step 616 may be selected on screen 714 as going above and beyond, continuous improvement, rolling up sleeves, leaving others better off, extraordinary listening, remaining flexible, adaptability, clear communication or empowering others. Identification of primary feelings in step 618, are also shown as input on screen 716 as selections for happy, motivated, confident, relieved, focused, united, hopeful, honored, inspired, thankful, excited, informed, energized, or optimistic. As also shown in narrative input screen 718, a story text input in step 620 is implemented with a typed or uploaded file using functional commands or a text entry box. In addition to a story about a personal or group success, a user may alternatively request an individual or group be recognized for an award, or applaud the success immediately, or seek input and comment from others. Such awards or recognition could, in different embodiments, be selected from the organization's existing rewards programs, or could be selected from a customized inventory of available rewards or awards.

As described above, because the story information is input in a structured format, the story data can be readily organized and analyzed. For example, stories having similar key players (e.g., customers) or the same themes (e.g., innovation or collaboration) may be easily identified and analyzed. Through such systematic recording and organizing of the stories, analysis can be easily completed of the recorded story information to provide analytics and comparisons of individuals, including employees, or users 130 against other individuals. As such, analytics can show an employee how he or she compares in relation to other employees or how an organization compares in relation to other organizations. This is described in more detail in the following embodiments. Using analytics applied to stories and associated data, the platform's analytics engine assists in determining and individual's impact to an organization or career field. This is the basis for the intrinsic value of the platform of the embodiments for individuals and organizations.

Story data is used to produce a number of analytics, rankings and trends that are useful to organizations and individuals. Story Data and Analysis is shown through a wide range of depictions, illustrations, graphics, and alphanumeric indicators, and can be presented at the organization instance, organization profile, or user profile levels. Data is gathered from the stories users tell, stories they are named in, stories they comment on, and other aspects of story participation. Stories, data and analysis are used to identify, understand and improve employee, customer, student, member—engagement, satisfaction, impact, influence, and contribution. Using text analytics, statistical and relational word analysis and correlations the embodiments of the platform reveal story patterns that may not be visible through other means. This includes analysis of all aspects of story data including but not limited to story themes, goals, challenges, lessons-learned, etc.

As part of analytical processing, in some embodiments user and organization statistics and metadata are tracked in various exemplary categories that are described below. For the individual user, high-level data associated with stories someone tells, is named in, or contributes to, is recorded. Such exemplary data may include headlines, counts of story tags, percentage of stories a user is in compared to peers, percentage of stories related to a particular theme, etc. Organizations also have access to story statistics and can use the analytics processing engine on those statistics to capture varying analytical datasets of events occurring within the organization from the users' points of view. For example, an organization can determine how many stories are being told that are related to a particular challenge or obstacle and then determine how many times a particular solution is disclosed by a user that is related to that challenge. Further, an organization could determine how many stories are input that are related to an important theme and make management or internal communication or personnel changes based on the results.

In an embodiment, users have the ability to accumulate story points and other story accomplishments, which can be used by the analytics engine to rank users and compare to one another on a leaderboard. The platform presents individual, group or organization rankings based on computations and calculations derived from exemplary categories stories contributed, story inclusion, story impact, specific story engagement, achievements, contests, etc., or other non-limiting customized categories. For example, a leaderboard could rank who are the top storytellers for a particular month or year based on the stories receiving the most interaction from the other users within or outside of the organization, or alternatively, which users have been named in the most stories with innovation themes associated to them.

In another embodiment, analytics for Story Impact Indicators and Achievements are processed and tracked via the analytics engine. The indicators provide certain status marks related to the positive impact of user stories based on platform usage. For example, the platform analytics engine applies a scoring methodology to a user's participation in the platform, compares this score to the rest of the organization, and presents an impact score or meter that represents positive impact. The resulting calculation is called an Impact Achievement Level or Score and is presented to the user as daily, monthly and lifelong scores. This shows the user their relative impact evidenced through stories. In an exemplary analytical process, user accomplishments are tracked by platform analytics and include how often over a predetermined time period an individual user was a top contributor of stories, how many times did the user identify and recognize “innovation” theme, and how often over a time period was a user recognized for being included in the most stories related to “creativity” themes.

An additional exemplary scoring indicator that tracks organizational involvement is an Organization Story Engagement Score. This score provides a measure of overall user engagement based how active and engagement users are in sharing everyday stories with a positive impact.

Another exemplary method to track analytics relates to story challenge and game achievements. An organization or the platform has an option to launch a story game. For example, a story game can include a call to action for employees to identify stories related to “teamwork.”

Another embodiment of exemplary story data analytics provided by the analytics processor is the Net Story-Giver Indicator. This indicator is a ratio of stories told versus those stories in which the individual or organization is named. The indicator may be included as part of the user's personal profile. High Net Story Givers is a recognition that may be featured in an organization's instance. The Net Story-Giver Indicator may alternatively apply to an organization. The organization's indicator score can provide insight into how engaged the organization is with its clients, customers, partners and other secondary organizations.

In another embodiment, organizations can customize the platform to include exemplary options and tags related to certain themes or topics that are important to them to provide an indicator of Mission, Purpose, and Cultural Alignment. This indicator may include unique cultural attributes, values and other important organizational behaviors. Through the analysis of stories and story data the analytical engine provides indications of alignment, or lack thereof, with desired culture attributes.

In yet another embodiment of analytical evaluation, stories are captured in a way that includes emotional context in order to provide a Sentiment Analysis by an analytical engine. Using the story data to is being used to understand. Exemplary emotional attributes such as attitudes, feelings and emotions are captured in multiple themes or context such as story setting and emotional impact. In one embodiment, storytellers are provided the ability to add emotion associated with story setting. For example, input of a story into entry screens 700 may include a team that faced a new challenge, but came together in a new way to overcome it. The storyteller can select the emotion tag of “anxious” in input screen 716 to describe how the players were feeling when faced with the challenge. In an additional embodiment for Sentiment Analysis, the results are related to the emotional impact of the story on the user inputting the story. An example of an input process to capture this data includes the storyteller being prompted to answer the question, “what was the story's impact on you?” in screen 716. The storyteller may select an emotion tag of “inspired,” for example, or one of varying alternative feeling indicator inputs as described previously. The selection of emotion impact tags helps users better understand the positive impact their efforts make on other users and their respective organizations.

In further embodiments, the analytics engine of the system tracks users within one organization who input stories that mention or name another organization and/or its users. The result is a computation of an exemplary Customer/Client Engagement Index for an organization. A non-limiting example of this index is the calculation of the number and ratio of total stories in a given time period that include an outside customer as a named player. The Customer/Client Engagement Index may be used to assess positivity and depth of engagement with a various external stakeholders.

In other embodiments, the platform compiles metadata from all users and organizations to create a Public Index. This data is used to establish benchmarks that can be looked at across various attributes. Organizations and individual users have the ability to determine how and where they compare against benchmarks and with others based on exemplary and non-limiting factors such as geography, industry, role, etc.

In additional embodiments, the analytics engine calculates rankings to determine story and player of a predetermined prior period, such as a prior week or day. Story of the Day is calculated in real time and represents the story with the most views in a predetermined past period, such as a prior 24 hour time period. This can also be considered the most “Trending Story”. Story of the Week is calculated periodically for a previous weeks' time period and represents the story with the most views during the previous weekly period. An exemplary recognition represents the user with the most points accrued for a category or theme during a previous time period. An exemplary Player of the Week recognition may be calculated periodically for a previous weeks' time period. Points are also accrued through user actions such as inputting stories into the platform, being named in other users' stories, viewing stories, “liking” stories after viewing, etc. An alternative recognition term can also be named as the “User of the Week.”

Further, such analytics can relate to an organization or user to show who are the leaders, or prospective leaders; from which departments are the most or best stories coming; and for multi-location companies, which locations generate the best or most stories. Such data and information may be analyzed to determine how to encourage and engage employees and organization departments. Data may also be used to assess alignment of organization behavior and actions with published values, culture and brand. Such data can also be used to assess many other aspects of organizational conduct, performance, culture, marketing, employee, and customer engagement.

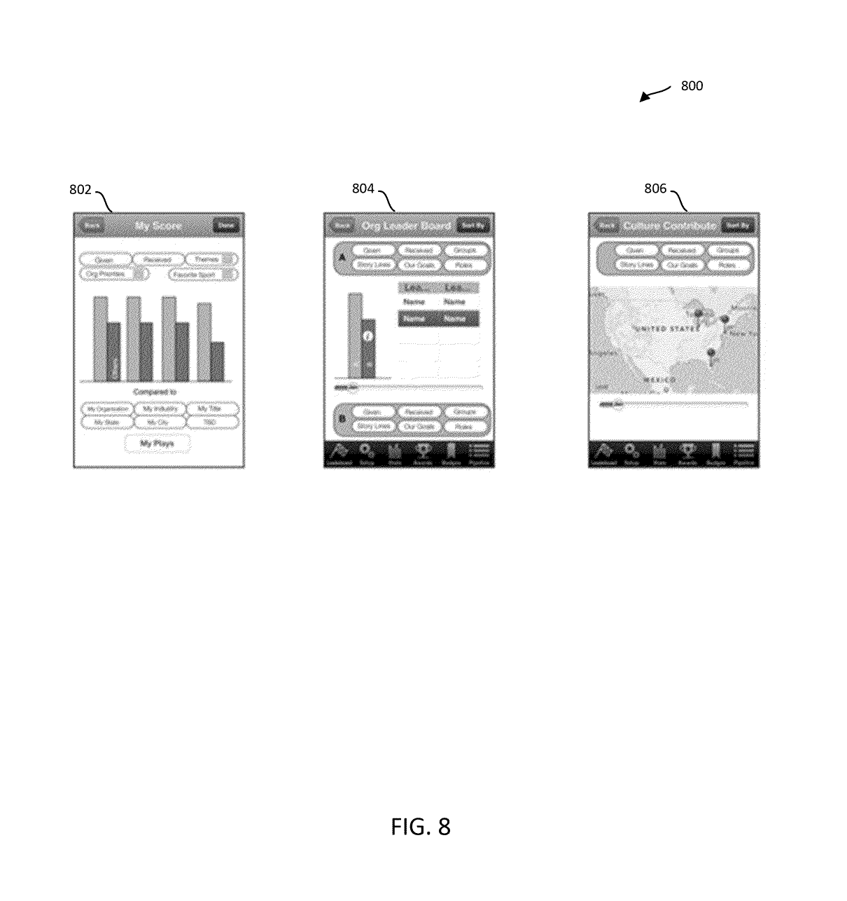

As shown in exemplary graphical user interface screens 800 in FIG. 8, exemplary analytics of the embodiments may be reported from analytics engine to mobile or computing devices in various ways to provide users 130 and organizations summarized analytics and reporting results. Sample reporting screen 802 comprises a report of comparison to others. This screen 802 allows a user to compare her own story data to other users in her organization or across other demographics. The user can analyze exemplary story data attributes such as similar themes, number of stories given or shared versus number of stories received or named in. The analytics provide an example of using story data to better understand the user's impact. In sample reporting screen 804, an organization can analyze its own story data to determine which users most frequently associate with the organization as a provider of stories or as those named in stories in order to discover its own high impact staff. For example, an organization can discover the top users associated with stories related to organizational values or goals. Another aspect provides an organization the ability to determine which users within certain groups contribute the highest number of positive stories related to another group. In another embodiment, sample reporting screen 806 provides an organization the ability to analyze story data and determine what locations of users across a geographic area are the most active in terms of contributing to the platform and what the associated themes are for each location. An organization may discover that one location stands out for high levels of customer engagement because of the high number of stories involving the certain group in a specific location.

In other embodiments, the analysis of the recorded stories and the associated story data can be used to reveal various meaningful insights and intelligence about workplace culture, performance, brands, and people. For example, story analytics data collected using the embodiments help users to better understand the impact their efforts are making as an employee, a volunteer, a student, or in any other related position. This type of an analytics calculation can be labeled an Impact Score by the platform.

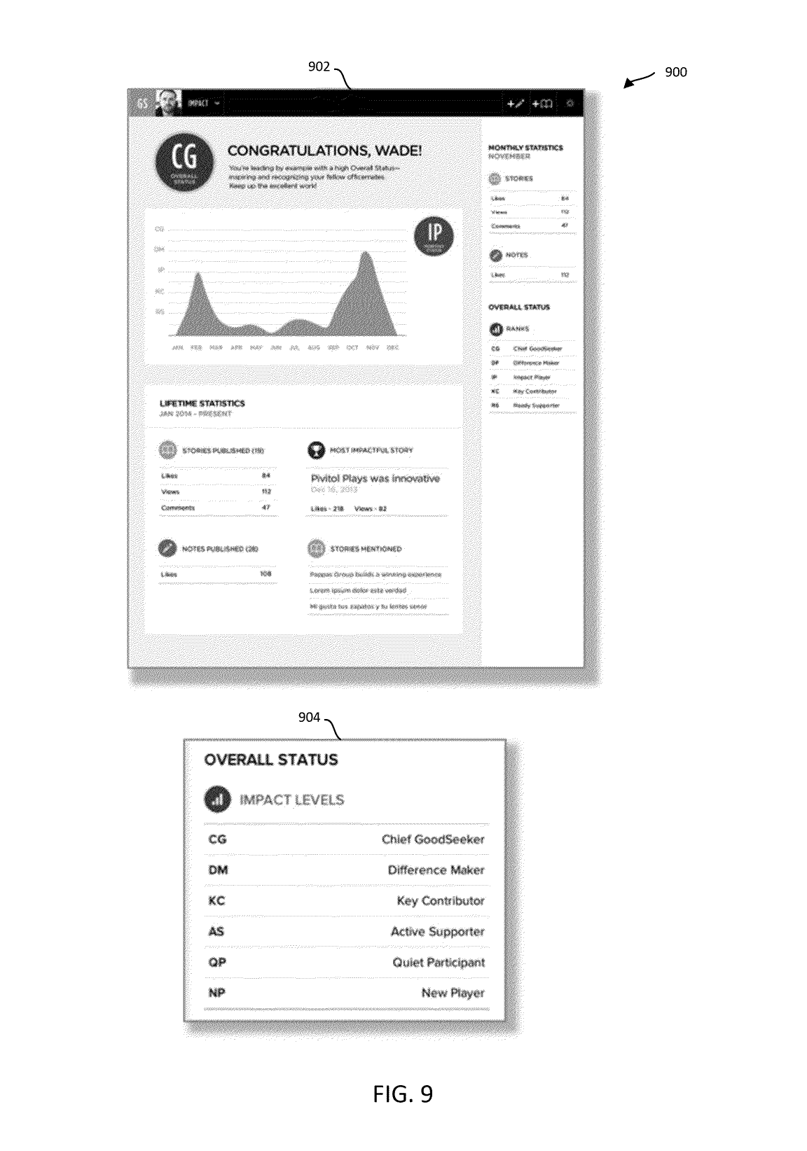

The Impact Score may be a quantitative measure of a user's impact derived from the data that are collected from stories created by an individual user, or the stories told about an individual user, and/or the interaction of other users with those stories. The Impact Score may be shown visually as a report 900, as illustrated in FIG. 9. In the embodiments, the Impact Score may represent an objective analysis of a user's impact as shown or depicted through narratives captured and shared through the platform. The Impact Score may be viewed as a form of recognition that rewards users who seek, create and share good stories, and all that the users represent in their organization or affiliated group.

In an exemplary embodiment, story points are automatically given to users for the publishing stories. More points are given based on how impactful the story is, based on likes, comments, etc. Story points are tracked by the individual and may be used to generate organization leaderboards or for the redemption of monetary and non-monetary rewards and incentives. In some embodiments, an organization can allow top story point earners to redeem points for organization branded materials, gift cards or other merchandise.

An additional way to earn story points is to respond to story challenges. Story challenges can be user-initiated, administer-initiated or automatically initiated by the platform. Storytellers, individuals named in stories, and those who contribute to positive stories can earn story points for participating in challenges. For a user-initiated challenge the individual invites peers to capture stories on a particular topic theme, challenge, solution, etc., by launching a challenge that gets posted to the organization's instance. The criteria for the challenge are set by the user and include timeframe, theme, challenge, solution or other criteria that story submissions must include. Other users accept the challenge and earn points for publishing stories that meet the criteria. As an incentive to get others to contribute, the user who launched the story challenge earns points when other users respond to the challenge. An example of this is an individual manager who wants to encourage his or her team to make a conscious effort to identify and share examples of teamwork with the group, and/or with the entire organization.

An organization administrator-initiated challenge is one where an appointed administrator launches a challenge and promotes it to the entire organization. The criteria for the challenge are set by the administrator and can include timeframe, theme, challenge, solution or other criteria that story submissions must include. Users can accept the challenge and earn extra points for publishing stories that meet the criteria within the timeframe. An exemplary challenge is an organization that wants to inspire multiple inputs of stories from its employees related to “living our values.” Another example is a sales team that just closed a large account due to the efforts of multiple team members. The sales manager may challenge the members to enter stories about individual and team impact on the sales efforts.

Another example relates to story challenge and game achievements. From time to time an organization or the platform automatically launches a story game. For example, a story game can include a call to action for employees to identify stories related to “teamwork.” Still further examples of accomplishments that are tracked include how many times during the course of a year were an individual a top contributor of stories. Additional examples include how many times did the individual identify and recognize “innovation.” Further, another example may include how many months during the course of a year was an individual recognized for being included in the most stories related to “creativity”?

The following exemplary score cards are included to more clearly demonstrate the overall nature of the embodiments and are not intended to limit the scope of the invention. The table below, titled “Points Available,” lists exemplary actions for which the recipient of an Impact Score might receive credit, as well as an example number of points that might be allocated for each action.

### Points Available

| Action | Recipient | Points |
|---|---|---|
| Mentioned as a | Mentioned Player | 6 points |
| player in a story | | |
| Created a story | Story Author | 3 points |
| Add a note | Contributor (no points for | 0.5 points |
| | Story Authors adding notes) | |
| Story Receives | Players Mentioned in the | 0.5 points |
| a Comment | Story, Story Author | |
| Note Receives | Note Author | 0.5 points |
| a Comment | | |
| Story Receives | Players Mentioned in the | 0.02 points |
| a Like | Story, Story Author | |
| Note Receives | Note Author | 0.02 points |
| a Like | | |
| Story Receives | Story Author | .03 points |
| View | | |
| Note Receives | Note Author | .03 points |
| a View | | |

The Impact Score may be calculated, for example, as follows. First, the points are compiled for the recipient. Next, users are ranked. Then percentiles are determined. And, finally, the Impact Score is calculated.

To illustrate, suppose that, in September, a user named Martin is mentioned in four stories, creates five story notes, and writes one story himself. Martin's Impact Score is summarized in the table below. His Impact Score is determined by, first, compiling the 29.58 total points. These points indicate that Martin has the third highest involvement with the positive stories being told within this organization. This rank places him in the 95th percentile. Thus, Martin presently has a 9.5 Impact Score.

### Martin Impact Score

| | Recipient of | | | Total |
|---|---|---|---|---|
| Action | points | Points | Instances | Points |
| Mentioned as a | Mentioned Player | 6 | 4 | 24 |
| player in a story | | | | |
| Created a story | Story Author | 3 | 1 | 3 |
| Add a note | Contributor (0 points | .5 | 5 | 2.5 |
| | for Authors | | | |
| | adding notes) | | | |
| Story Receives | Players mentioned | 0.5 | 0 | 0 |
| a Comment | in the Story, | | | |
| | Story Author | | | |
| Note Receives | Note Author (story | 0.5 | 0 | 0 |
| a Comment | authors ineligible) | | | |
| Story Receives | Players mentioned | 0.02 | 4 | 0.08 |
| a Like | in the Story, | | | |
| | Story Author | | | |
| Note Receives | Note Author | 0.02 | 0 | 0 |
| a Like | | | | |
| Story Receives | Story Author | .03 | 0 | 0 |
| View | | | | |
| Note Receives | Note Author (story | .03 | 0 | 0 |
| a View | authors ineligible) | | | |

Using administrative functions of the platform, periodic and historical versions of the Impact Score can be created. For example, scores may be reset on a monthly basis to avoid penalizing newer hires; scores may be re-calibrated daily, or perhaps overnight; and months with a score of zero may be discounted so that they do not count against the user. Historically, for example, the cumulative average of a recipient's monthly scores can be calculated and the recipient can take an historical score with them after leaving the organization. FIG. 9 shows an embodiment of a participant's Impact Score, in graphical form suitable for display on a user's computing or mobile device, by month and by week. The user can observer his calculated impact score as well as compare his score to an overall score for the user's organization.

In addition to Impact Scores, the platform provides various Descriptors/Status Markers that are derived from Impact Scores. These descriptors may be used in conjunction, or independently from the numerical score. Status markers are determined based on relative comparison to the rest of the organization, and based on percentiles where:
i. CG, Chief GoodSeeker—percentile>=8. Impact Level=Extreme
ii. DM, Difference Maker—percentile>=6. Impact Level=High
iii. KC, Key Contributor—percentile>=4. Impact Level=Considerable
iv. AS, Active Supporter—percentile>=2. Impact Level=Moderate
v. QP, Quiet Participant—percentile>=0. Impact Level=Initial
vi. New Player—no points accumulated at all.

Exemplary Impact Status Markers are depicted in the tracking chart of FIG. 9 as reported periodically such as on a daily, monthly, and overall lifetime basis. The user has the ability to filter or view status markers based on current or prior organization affiliations. An “Overall Status,” indicates that the user is a certain score for the lifetime of the user's account, which may reflect story data gathered from multiple organizations. For example, a status is based on an average percentile ranking for all the months a user has been working at the organization and is updated on a monthly basis. The user's “So far this month” status is the average of all daily statuses for the month. Any activity on the site will update this score dynamically. The user's “daily status” shown on the chart is reporting the user's status on a specific day. A data point is added every day for the previous day.

Comparisons between or among Impact Scores and Impact Status Markers are also contemplated. Comparisons can be made at various levels, including: (1) self over time; (2) the current organization as a whole; (3) defined groups and teams; (4) roles and titles; (5) industries; (6) geographies; (7) story attributes, keywords and topics; and (8) other variables.

The Impact Score may be connected, in preferred embodiments, to an individual's profile that is created using the inventive method and systems as a measure of overall user engagement based how active and engaged users are in sharing everyday good stories. As long as the individual has an active account, that individual can have a profile and an Impact Score. While the Impact Score may be maintained private, as determined by the individual, the user/individual may also decide whether to make his or her score public. Given the dynamic nature of Internet views and “touches” to a story, an individual's Impact Score will similarly be dynamic and variable over time. Additionally, a Net Story-Giver Indicator can be used as part of a user's profile as a ratio of stories told vs. those where the individual or organization is named. High Net Story Givers are also featured in their organization's instance. This also applies at the organization level. Organizations are able to include clients, customers, partners and other secondary organizations in stories. In this case, the Net Story-Giver Indicator helps to explain how engaged the entity is with others. Accordingly, the Impact Score is a true real-time indicator of the positive impact of the individual or an organization.

As summarized above in the example calculation, the points associated with an individual's Impact Score provide a form of weighting that may go into the Impact Score. Over time the Impact Score can be used to show the positive impact of an individual during his or her career. Moreover, the Impact Score can encourage personal improvement through benchmarking against peer data associated with attributes or categories such as organization title, industry sector, geography or location, role, and many other metrics. Individuals accumulate story data about themselves over their career.

In the embodiment, the central platform metadata is maintained from all users and organizations. This data is used to establish benchmarks that can be looked at across various attributes. Organizations and individuals have the ability to see where they stand against benchmarks and to compare with others based on geography, industry, role, etc.

In still other preferred embodiments, the Impact Score may be determined or calculated in an aggregate fashion. More particularly, in a standard set up, an organization may not have access to an individual's personal Impact Score, unless the individual decides to make his or her Impact Score public. A user will have the ability, however, to see and compare aggregate Impact Score data as categorized by title, job role, geography, industry, and other recognized metrics. Aggregate impact score data and associated meta-data can be used as a unique or supplementary measure of overall user engagement, workplace positivity and satisfaction. Organizations may wish to share, internally or externally, their overall Impact Score as an indicator of the organization's culture, recruitment brand or overall workplace positive “feeling.” Organizations can also use the aggregate Impact Score data and associated story meta-data as part of, or to support, recruiting, talent management and other human capital planning needs.

In an additional embodiment, after leaving a job, or affiliation with a specific organization, users may also create an account that is independent of their relationship to any specific organization. A user profile contains certain stories, metrics and metadata. Stories and story data are maintained in a user story database at an independent central database. User accounts, user story profiles and associated user story database are portable across employers and affiliations. This means that a user owns their account over their lifetime, and builds their story profile over their lifetime, but the story data stays with the user and is included in their Story Profile. Story Profiles, and any data in these profiles, are sharable through various channels, at the discretion of the account holder. An individual can share access to their profile that is stored at a central platform database outside of their organization. Others can ask for access to the user's profile, and the user can give or deny permission. An individual can further share their entire profile, or parts of their profile, through other social media and personal networking services. An individual can also share stories that a current or prior affiliated organization publishes to the central database. Additionally, individuals earn various status marks and other measures of positive impact associated with external stories. These indicators, scores and related metrics can be used in the search for employment or membership. For example, an individual may give permission to see their external profile to a potential employer or member as a way to present a unique view on their personal brand and positive impact on prior organizations. A user can also link their story profile to job boards and other third-party job matching websites. Further, in preferred embodiments, the Impact Score can be transferred or communicated to current and future employers as an unbiased and relative example of an individual's positive impact on other individuals, the organization, and/or the employer.

Certain features and unique aspects of embodiments of the inventive methods and systems are further outlined in the table below, which lists exemplary features for individuals (e.g., public and private website recognition of goal achievement; comparative analytics with respect to other individuals; and an individual profile page), and exemplary features for organizations (e.g., various recordable scores for users and customer engagement, culture alignment, performance alignment, comparative analytics with respect to other organizations, and new business leads through the public website.

| For the Employee | For the Employer |
|---|---|
| Enriches the work experience | Shows employees organization cares |
| Understanding and | Widen the audience for recognition |
| monitoring personal brand | Good News feed keeps all informed |
| Self-assessment of positive | Discover and promote lessons-learned |
| impact and contribution | Clearer view of workforce characteristics |
| Strengths identification and | Culture, values and story alignment |
| personal betterment | Employees as ambassadors for brand |
| Better self-awareness | Boosts productivity, reduces spend |
| Clarity on impact and career | Helps retain the best and brightest |
| legacy | Jump start a new employee |
| Visibility by management | Assessment of overall, individual or |
| Stronger connection to peers | group positive impact and contribution |
| and org. | Assessment of culture and alignment of |
| Fulfills desire to teach and | stories with organizational mission |
| help others | Understanding brand (brand perceptions |
| Enhanced awareness of org | evidenced through stories) |
| values | Identification and sharing of organization |
| Teaches people the power of | improvement opportunities |
| stories | Platform for delivering and tracking peer- |
| Delivering and tracking peer | to-peer employee recognition |
| recognition to and from | A means to provide public recognition to |
| Work legacy stories tracking | employees |
| and sharing | Support or replace existing employee |
| Supplemental resume | rewards programs |
| content and validation of | Augment employee performance reviews |
| impact | Idea generation through stories |
| Job Matching - individual is | To identify stories that can be used for |
| creative, organization needs | marketing |
| creative. | Candidate Matching - Organization needs |
| | more creative people, finds candidate |
| | who has story profile that shows they are |
| | creative. Organization and individual |
| | impact scores and other metrics can be |
| | used to align candidate with the right job |
| | and organization. |

As disclosed above, each story has structure and data associated with its principal elements including such things such as setting, characters, goals, conflict, resolution, morals, lessons-learned and emotion. In the embodiments, quantitative and qualitative analyses of the story's words, numbers, images, symbols, context and other data sets associated with a large number of related stories and narratives may be undertaken. Such analyses would be useful to possibly reveal particular intelligence, trends, patterns and various other metrics relating to the stories and narratives analyzed.

A further embodiment relates to the control and ownership of the profile created. Instead of having such profile be controlled and owned by the organization, the profile may be controlled by the user-creator. In such an embodiment, the attributes and at least certain aspects of the entered data, including data relating to the author's relation to the story could be retained at the author's profile level on an external platform server if the author were no longer connected to the organization. This tiered embodiment would permit for varied connections between users and varied organizations, as a user may change his association with an organization.

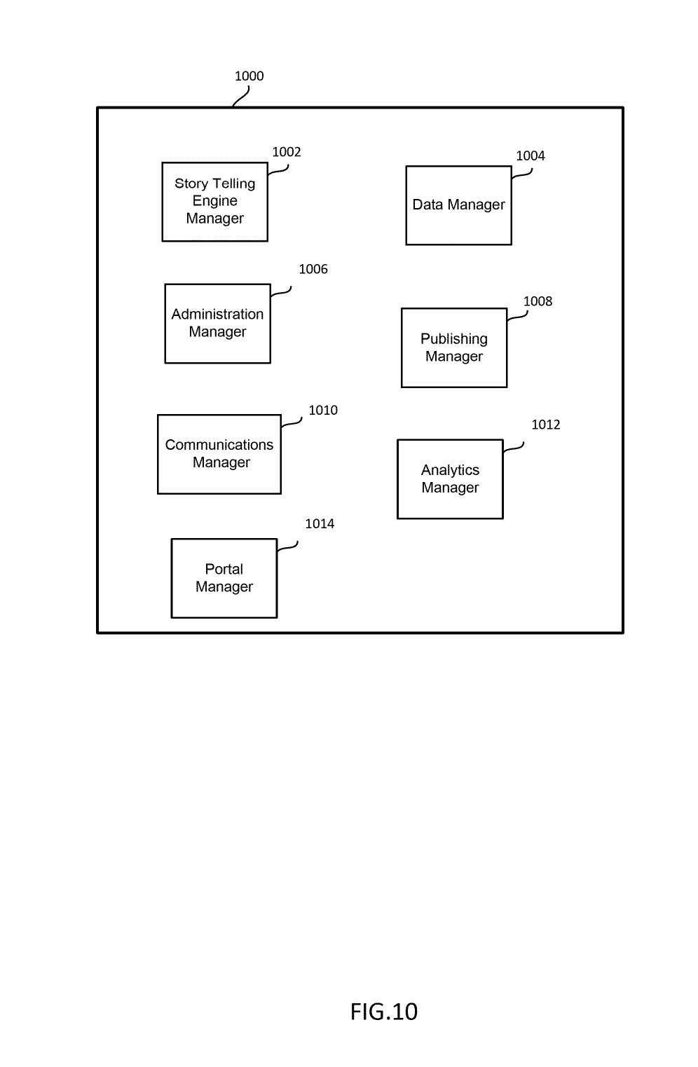

FIG. 10 illustrates embodiments of software managers of processor, server, or computing device that perform the methods or operate the systems of the present embodiments. The functional units described in this specification have been labeled as managers or directors. A manager and/or director may be implemented in programmable hardware devices such as field programmable gate arrays, programmable array logic, programmable logic devices, or the like. The manager and/or director may also be implemented in software for execution by various types of processors. An identified manager and/or director of executable code may, for instance, comprise one or more physical or logical blocks of computer instructions which may, for instance, be organized as an object, procedure, function, or other construct. Nevertheless, the executables of an identified manager and/or director need not be physically located together, but may comprise disparate instructions stored in different locations which, when joined logically together, comprise the manager and/or director and achieve the stated purpose of the manager and/or director. Indeed, a manager and/or director of executable code could be a single instruction or many instructions and may even be distributed over several different code segments, among different applications, and across several memory devices. Similarly, operational data may be identified and illustrated herein within the manager and/or director, and may be embodied in any suitable form and organized within any suitable type of data structure. The operational data may be collected as a single data set, or may be distributed over different locations including over different storage devices, and may exist, at least partially, as electronic signals on a system or network.

Referring further to FIG. 10, Story Telling Engine Manager 1002 includes logic that performs the functions related story telling framework/server 142 and other functions described by the embodiments. Data manager 1004 includes logic that manages system cloud database 118 and other data management functions described in the embodiments. Administration manager 1006 includes logic that manages the functions of the embodiments providing capability to administratively manage the system 100 described in the embodiments. Publishing manager 1008 includes logic that provides the functions and management of public site 112 and private customer sites 114 for publishing stories and reports of analytics. Communications manager 1010 includes logic that provides the functions and management of communications between users 130 and servers and databases of system 100 through a network such as the Internet 124. Analytics manager 1012 includes logic that provides the functions and management of an analytics engine for analyzing and reporting data according to the embodiments. Portal manager 1014 includes logic that provides the functions and management of content management system 116 according to the embodiments.

While certain exemplary embodiments have been disclosed and described, there are other method variations and system configurations for effectively recording, organizing, and analyzing employee or group member recognition through structured storing telling, along with associated methods for publishing selected stories, of those recorded and analyzed, for feedback and further recognition, with such other methods and systems being equally possible using the method steps and system elements and architectures as disclosed herein. Such equivalent configurations are deemed fully within the scope of the inventive methods and systems for employee or group member recognition through structured story telling.

The computing devices on which the system is implemented may include a central processing unit, memory, input devices (e.g., keyboard and pointing devices), output devices (e.g., display devices), and storage devices (e.g., disk drives or other non-volatile storage media). The memory and storage devices are computer-readable storage media that may be encoded with computer-executable instructions (e.g., software) that implement or enable the system. In addition, the data structures and message structures may be stored on computer-readable storage media. Any computer-readable media claimed herein include only those media falling within statutorily patentable categories. The system may also include one or more communication links over which data can be transmitted. Various communication links may be used, such as the Internet, a local area network, a wide area network, a point-to-point dial-up connection, a cell phone network, and so on.

Embodiments of the system may be implemented in various operating environments that include personal computers, server computers, handheld or laptop devices, multiprocessor systems, microprocessor-based systems, programmable consumer electronics, digital cameras, network PCs, minicomputers, mainframe computers, distributed computing environments that include any of the above systems or devices, set top boxes, systems on a chip (SOCs), and so on. The computer systems may be cell phones, personal digital assistants, smart phones, personal computers, programmable consumer electronics, digital cameras, and so on. The system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

Embodiments may be implemented as a computer process, a computing system or as an article of manufacture such as a computer program product of computer readable media. The computer program product may be computer storage medium readable by a computer system and encoding a computer program instructions for executing a computer process. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an” and “the” are intended to include plural forms as well, unless the context clearly indicates otherwise. It will be further understood that the terms “comprises” and/or “comprising,” when used in this specification, specific the presence of stated features, integers, steps, operations, elements, and/or components, but do not preclude the presence or addition of one or more other features, integers, steps, operation, elements, components, and/or groups thereof.

The corresponding structures, material, acts, and equivalents of all means or steps plus function elements in the claims below are intended to include any structure, material or act for performing the function in combination with other claimed elements are specifically claimed. The description of the present invention has been presented for purposes of illustration and description, but is not intended to be exhaustive or limited to the invention in the form disclosed. Many modifications and variations will be apparent to those of ordinary skill without departing from the scope and spirit of the invention. The embodiment was chosen and described in order to best explain the principles of the invention and the practical application, and to enable others of ordinary skill in the art to understand the invention for embodiments with various modifications as are suited to the particular use contemplated.

It will be apparent to those skilled in the art that various modifications and variations can be made in the disclosed embodiments of the disclosed device and associated methods without departing from the spirit or scope of the invention. Thus, it is intended that the present invention covers the modifications and variations of the embodiments disclosed above provided that the modifications and variations come within the scope of any claims and their equivalents.

What is claimed is:

1. A method, comprising:
creating, by a user via a computing device networked to a platform server, a user profile and saving the user profile into a platform database;
searching, on the platform database, for an organization profile of an organization related to the user,
wherein if the organization profile does not exist on the platform database, then creating, by the user on the platform server, an organization instance comprising the organization profile and linking the user profile to the organization instance, and
wherein, if the organization instance exists on the platform database, then linking the user profile to the organization instance;
entering, by the user via the computing device, a plurality of stories comprising story data in structured format that capture a plurality of story elements and saving the stories into the story database;
linking the stories to the user profile; and
publishing at least one of the stories to a private site feed on the platform that is linked to the organization's instance.

2. The method of claim 1, further comprising:
broadcasting, via the organization's private feed site to other individuals who are part of the organization, a request for additional input to the stories; and
collecting, via new user profiles created by the other individuals in the organization, the additional input to the stories in the story database.

3. The method of claim 1, wherein the story elements comprise one of a setting, characters, goals, conflict, resolution, morals, lessons-learned, and an emotion.

4. The method of claim 1, further comprising:
submitting, by the organization, at least one of the user stories to an administrator of the platform; and
posting, by the platform administrator, the user story to the platform's public website.

5. The method of claim 1, wherein the entering the plurality of stories comprises entering a story that names an external individual related to a secondary organization that is not part of the user's organization, and
further comprising sending a notification to the external individual with a request to create a new user profile and new secondary organization instance on the platform.

6. The method of claim 1, further comprising:
removing the link from the user profile to the organization; and
linking the user profile to a new organization instance while retaining stories entered by the user with the user profile.

7. The method of claim 1, further, comprising:
entering, via a plurality of computing devices that are networked to the platform server, by a plurality of new users each with new user profiles linked to the organization instance, a plurality of additional stories comprising additional story data in structured format that capture a plurality of story elements and user names and saving the plurality of stories into the story database; and
analyzing, using an analytics engine of the platform, at least part of user profiles data, organization data, user stories and new user stories and story data in the database.

8. The method of claim 8, wherein the analyzing step further comprises performing relational analysis upon story data and participation by the user and new users in the platform to determine story patterns.

9. The method of claim 8, wherein the analyzing step further comprises tracking metadata of user and new user participation and story element data to determine organization story statistics.

10. The method of claim 9, wherein the analyzing step further comprises awarding story points to each user and ranking the user relative to the new users based the story points.

11. The method of claim 8, wherein the analyzing step further comprises determining story impact indicators and achievement analytics that relate the user's positive impact of user stories relative to new user stories based on platform utilization.

12. The method of claim 8, wherein the analyzing step further comprises determining an organization story engagement score for the user relative to the new users to measure user engagement with the platform.

13. The method of claim 8, wherein the analyzing step further comprises determining a net story-giver indicator as a ratio of stories entered by the user versus a number of stories in which the user is named by the new users.

14. The method of claim 8, wherein the analyzing step further comprises analyzing the story data to determine a mission, purpose, and cultural alignment as an indication of organization behavior.

15. The method of claim 8, wherein the analyzing step further comprises determining a sentiment analysis using the story data to analyze an emotional context of stories that are related to the organization.

16. The method of claim 8, wherein the analyzing step further comprises determining a customer/client engagement index of the story data as an indicator of stories that include an outside customer of the organization.

17. The method of claim 8, wherein the analyzing step further comprises determining a public index as a compilation of story data from a plurality of organization instances of the platform based on a classification.

18. The method of claim 8, wherein the analyzing step further comprises determining an impact score of the user of the platform that is a quantitative measure of a user's impact to the organization.

19. A system, comprising:
a computing device, networked to a platform server, for creating a user profile and saving the user profile into a platform database;
a search engine on the platform database, for searching for an organization profile of an organization related to the user,
wherein, if the organization profile does not exist on the platform database, then creating, by the user on the platform server, an organization instance comprising the organization profile and linking the user profile to the organization instance, and
wherein if the organization instance exists on the platform database, then linking the user profile to the organization instance;
a story manager for entering, by the user via the computing device, a plurality of stories comprising story data in structured format that capture a plurality of story elements, saving the stories into the story database, and linking the stories to the user profile; and
a publishing manager for publishing at least one of the stories to a private site feed on the platform that is linked to the organization's instance.

20. The system of claim 19, wherein the publishing manger broadcasts, via the organization's private feed site to other individuals who are part of the organization, a request for additional input to the stories.
